(19) United States
(12) Patent Application Publication
(10) Pub. No.: US 2021/0206088 A1
(43) Pub. Date: Jul. 8, 2021

(54) 3D PRINT MATERIAL SHUT-OFF

(71) Applicant: HEWLETT-PACKARD DEVELOPMENT COMPANY, L.P., Spring, TX (US)

(72) Inventors: Brent EWALD, Vancouver, WA (US); Mike RODE, Vancouver, WA (US); Tristan DUDIK, Vancouver, WA (US); John GEILE, Vancouver, WA (US)

(73) Assignee: HEWLETT-PACKARD DEVELOPMENT COMPANY, L.P., Spring, TX (US)

(21) Appl. No.: 16/075,913

(22) PCT Filed: Apr. 21, 2017
(86) PCT No.: PCT/US2017/028887

§ 371 Date: Aug. 6, 2018

(51) Int. Cl. B29C 64/329; B29C 64/245; B33Y 40/00; B33Y 30/00; B33Y 10/00

(52) U.S. Cl. CPC B29C 64/329; B29C 64/245; B33Y 10/00; B33Y 30/00; B33Y 40/00

(57) ABSTRACT

A 3D print material shut-off apparatus includes a discharge opening isolator, disposed in a first region of a 3D printer and a print material hopper including a discharge opening at a bottom portion of the print material hopper to discharge a print material from the print material hopper in a second region of the 3D printer adjacent to the first region. The discharge opening isolator is to occlude the discharge opening of the print material hopper when the print material hopper is in the first region.

### BACKGROUND

3D printers include a movable platform on which successive layers of a 3D print material (e.g., a nylon powder, a metal powder, etc.), are applied, spread and fused or bonded, layer-by-layer, to build a product. In a powder bed fusion process, a 3D material applicator applies a layer of the 3D print material in a predetermined thickness across a work area or build area of the movable platform. A 3D print material bonding device then selectively applies energy to the layer of the 3D print material to fuse or bond selected portions of the layer of the 3D print material corresponding to a cross-section of the desired product at the vertical position of the layer. This process continues, layer-by-layer, until the entire product is built from the assembled layers.

### BRIEF DESCRIPTION OF THE DRAWINGS

FIGS. 1A-1D depict a top view of an example 3D printer showing stages of movement of a print material hopper relative to a discharge opening isolator in accordance with teachings of this disclosure.

FIGS. 2A-2F depict another top view of an example 3D printer showing stages of movement of a print material hopper relative to a plurality of discharge opening isolators in accordance with teachings of this disclosure.

FIG. 3 is a top perspective view of an example print material hopper in relation to an example discharge opening isolator in accordance with teachings of this disclosure.

FIG. 4 is a bottom perspective view of an example print material hopper in accordance with teachings of this disclosure.

FIG. 5 is a cut-away side view showing an example print material hopper moving in relation to an example delivery plate to discharge a layer of powder on the example delivery plate in accordance with teachings of this disclosure.

FIG. 6 is a cut-away side view showing the example of FIG. 5, wherein the example print material hopper has completed the discharge of the layer of powder on the example delivery plate and is moving onto the example discharge opening isolator in accordance with teachings of this disclosure.

FIG. 7 is a cut-away front view of the example of FIG. 5, wherein the example print material hopper is shown to discharge the layer of powder on the example delivery plate in accordance with teachings of this disclosure.

FIGS. 8A-8B are cut-away side views of an example first state and an example second state of an example 3D print material shut-off apparatus having a stationary print material hopper and a moving discharge opening isolator in accordance with teachings of this disclosure.

FIG. 9 is a flowchart representative of example method which may be executed to implement the example discharge opening isolator of FIGS. 1A-8 in accordance with teachings of this disclosure.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

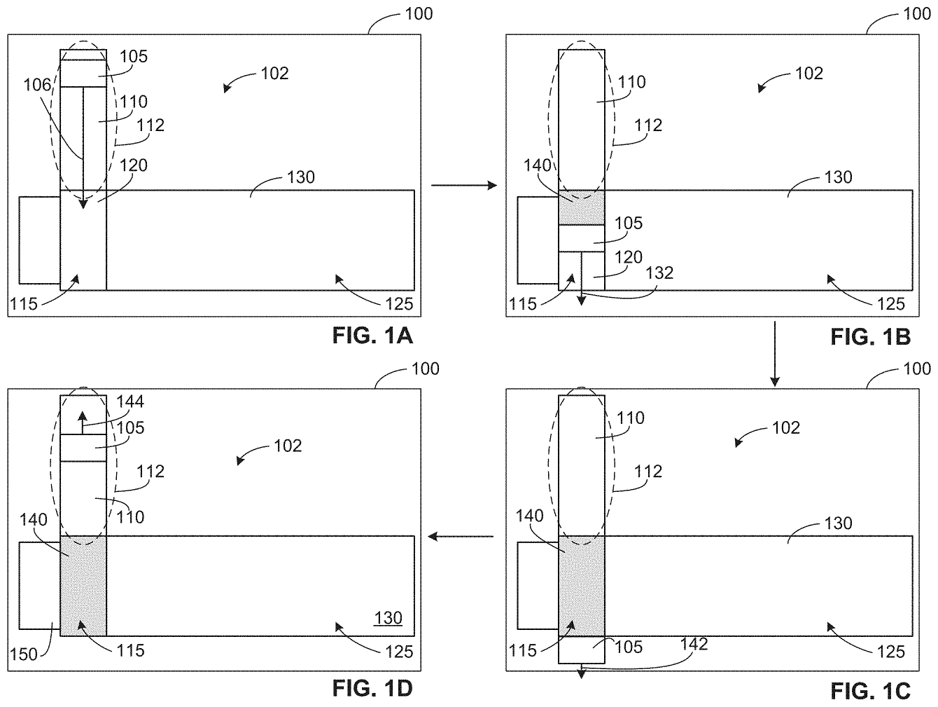

FIGS. 1A-1D depict top views of an example 3D printer 100 and an example 3D print material shut-off apparatus 102 including an example print material hopper 105 and an example discharge opening isolator 110. FIGS. 1A-1D show a top view of stages of movement of the example print material hopper 105 relative to the example discharge opening isolator 110, over which the example print material hopper 105 travels, during an example iteration of an additive manufacturing process.

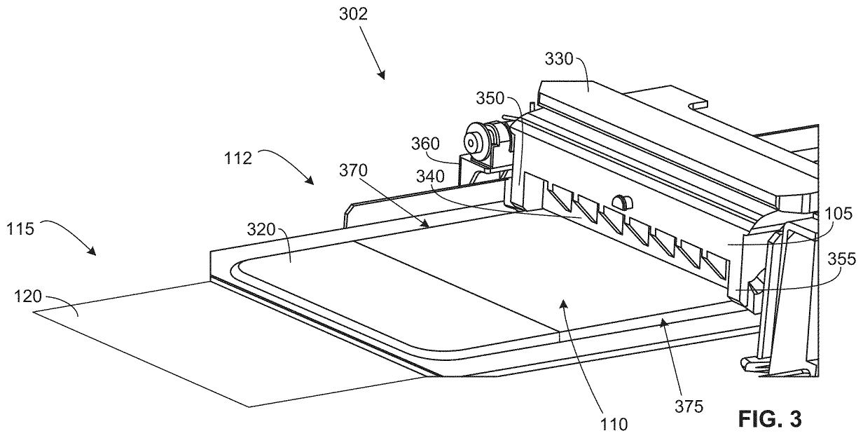

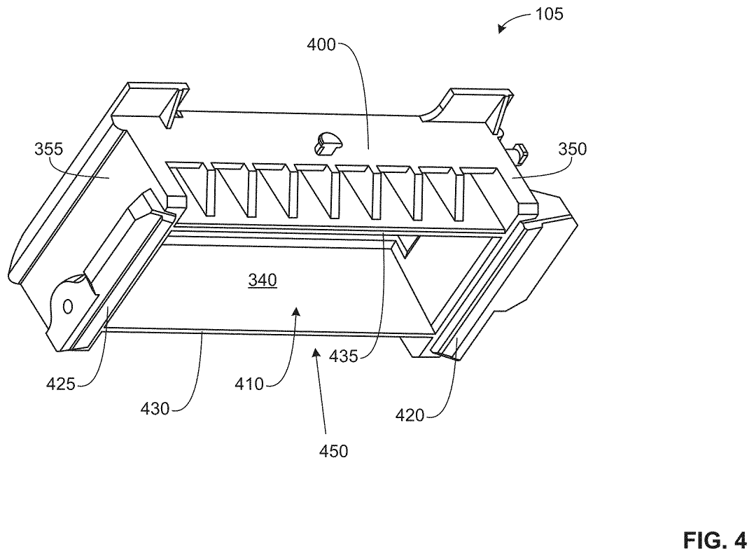

In FIG. 1A, the example discharge opening isolator 110 is disposed in an example first region 112 of an example 3D printer 100. The example print material hopper 105 is shown to move in the direction of the arrow 106 over the example discharge opening isolator 110. The example print material hopper 105 includes a discharge opening (see FIG. 3) at a bottom portion of the example print material hopper 105 to discharge a print material from the print material hopper 105 in an example second region 115 of the example 3D printer 100 adjacent to the example first region 112. The example discharge opening isolator 110 is to occlude the discharge opening of the example print material hopper 105 when the example print material hopper 105 is in the example second region 115. In some examples, the example second region is an example delivery plate 120 adjacent an example print region 125 of the 3D printer including an example movable platform 130 upon which a workpiece is built. In some examples, the example second region 115 on which the print material is discharged is the example print region 125 of the 3D printer. In other words, in some examples, the example print material hopper 105 is to discharge the print material directly on the example movable platform 130.

In FIG. 1B, the example print material hopper 105 is shown to move in the direction of the arrow 132 along a path including the example first region 112 of the example 3D printer 100 and the example second region 115 of the example 3D printer 100 adjacent to the example first region 112 of the example 3D printer 100. As noted above, the example print material hopper 105 includes a discharge opening at a bottom portion to discharge a print material. When the example print material hopper 105 is in engagement with the example discharge opening isolator 110, the discharge opening is occluded and is unable to discharge the print material (see, e.g., FIG. 1A). However, as the example print material hopper 105 disengages from the example discharge opening isolator 110, the portion of the example print material hopper 105 discharge opening that is free of engagement with the example discharge opening isolator 110 is permitted to discharge the print material from the example print material hopper 105 (see, e.g., FIG. 1B). For instance, as seen in the example of FIG. 1A, no print material is discharged in the example first region 112, whereas in the example of FIG. 1B, a layer 140 of print material is shown to be discharged in the example second region 115 on the example delivery plate 120.

In FIG. 1C, the example print material hopper 105 is shown to have completed travel along a path including the example first region 112 of the example 3D printer 100 and the example second region 115 of the example 3D printer 100, has discharged a layer of example layer 140 of print material along the example second region 115 on the example delivery plate 120, and has substantially completed travel in the direction of the arrow 142 along the path including the example first region 112 of the example 3D printer 100 and the example second region 115 of the example 3D printer 100.

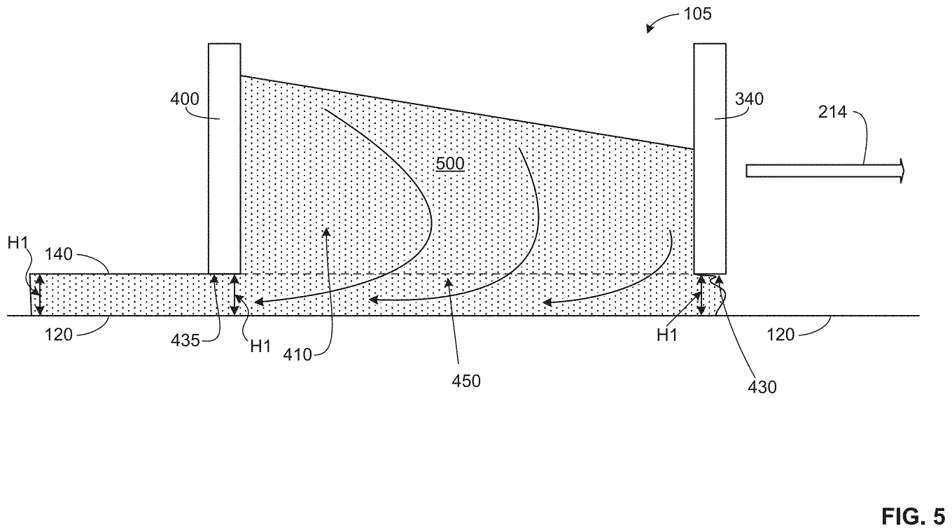

In FIG. 1D, the example print material hopper 105 is shown to have moved back along the path, over the example second region 115 and the example delivery plate 120, in the direction of the arrow 144. In some examples, when a direction of motion of the example print material hopper (e.g., 105) is reversed from the position depicted in FIG. 10 to move back toward the example discharge opening isolator 110 of the example first region 112, some additional print material is discharged onto the existing example layer 140 to fill in the example 140 layer, to a predetermined height H1 (see FIGS. 5-7), to account for any print material settling that may occur between the first pass (FIGS. 1B-1C) and the second pass (FIG. 1D). In some examples, when a direction of motion of the example print material hopper (e.g., 105) is reversed from the position depicted in FIG. 10 to move back toward the example discharge opening isolator 110 of the example first region 112, the example print material hopper 105 is depleted of the print material and no additional print material is discharged in the movement over the existing example layer 140.

In FIG. 1D, the example print material hopper 105 is in the example first region 112 is in the process of engaging the example discharge opening isolator 110 to complete an example cycle of movement of the example 3D print material shut-off apparatus 102. Following the formation of the example layer 140 of print material on the example delivery plate 120, an example spreader 150 then advances to spread the print material on the example delivery plate 120 uniformly over the example movable platform 130 in the example print region 125, where the print material is further processed.

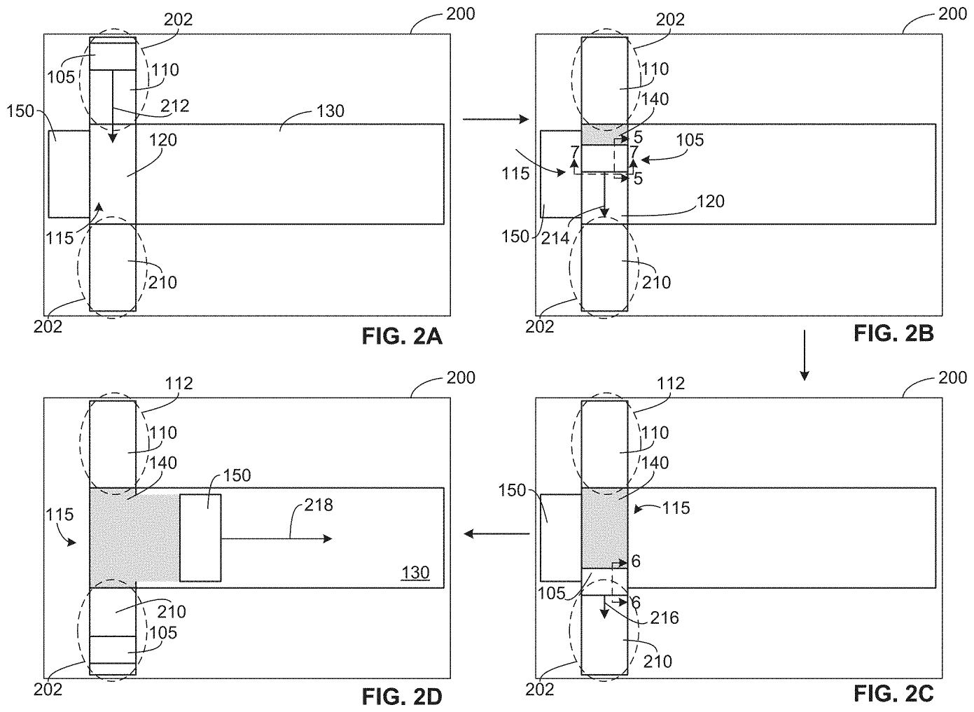

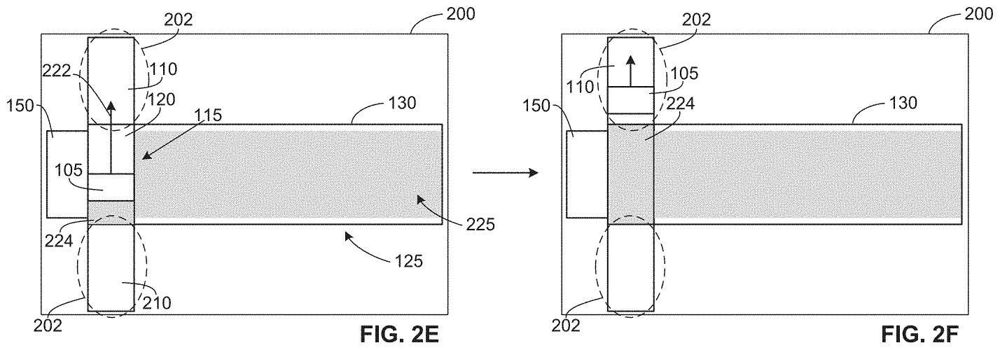

FIGS. 2A-2F depict a top down view of another example 3D printer 200 showing an example 3D print material shut-off apparatus 202 including the example print material hopper 105, the example discharge opening isolator 110 at a proximal end of the example delivery plate 120, and an example discharge opening isolator 210 at a distal end of the example delivery plate 120. FIGS. 2A-2F show stages of movement of the example print material hopper 105 relative to the example discharge opening isolator 110 and the example discharge opening isolator 210 during an example iteration of an additive manufacturing process.

In FIG. 2A, similar to FIG. 1A, the example print material hopper 105 is disposed on the example discharge opening isolator 110, which occludes the discharge opening at a bottom portion of the example print material hopper 105 to prevent discharge of a print material from the print material hopper 105 in the example first region 112 of the example 3D printer 200. FIG. 2A shows the example print material hopper 105 moving in the direction of the arrow 212 along a path over the example discharge opening isolator 110 in the example first region 112. In FIG. 2B, the example print material hopper 105 is shown to move in the direction of the arrow 214 along the path including the example first region 112 and the example second region 115 and is shown to discharge the layer 140 of print material in the example second region 115.

In FIG. 2C, the example print material hopper 105 is shown to have completed travel along the path including the example first region 112 of the example 3D printer 100 and the example second region 115 of the example 3D printer 100, has discharged a layer of example layer 140 of print material along the example second region 115 on the example delivery plate 120, and has moved along arrow 216 into engagement with the example discharge opening isolator 210 at the distal end of the example delivery plate 120. In FIG. 2C, the engagement of the example print material hopper 105 with the example discharge opening isolator 210 occludes the discharge opening of the example print material hopper 105 to prevent discharge of the print material.

In FIG. 2D, the example print material hopper 105 is stationary in a position where the example discharge opening isolator 210 occludes the discharge opening of the example print material hopper 105 to prevent discharge of the print material. In FIG. 2D, the example spreader 150 then advances in the direction of arrow 218 to spread the print material on the example delivery plate 120 uniformly over the example movable platform 130 to form a layer 225 in the example print region 125. The example spreader 150 then returns to the initial position shown in FIGS. 2A-2C. In FIG. 2E, the example print material hopper 105 then moves back along the path, in the direction of the arrow 222, over the example second region 115 to discharge a next layer 224 of print material on the example delivery plate 120 for a subsequent iteration of print material processing. In FIG. 2F, the example print material hopper 105 is again in the example first region 112 in the process of engaging the example discharge opening isolator 110. Movement of the example print material hopper 105 onto the example discharge opening isolator 110 completes an example cycle of movement of the example 3D print material shut-off apparatus 202.

FIG. 3 is a top perspective view of an example print material hopper 105 of an example 3D print material shut-off apparatus 302 including, the example discharge opening isolator 110 and an example ramp 320 disposed between the example second region 120 and the example discharge opening isolator 110. In the position indicated in FIG. 3, the example print material hopper 105 is disposed on the example discharge opening isolator 110, and an upper surface of the example discharge opening isolator 110 occludes the discharge opening at a bottom portion of the example print material hopper 105 to prevent discharge of the print material from the print material hopper 105 in the example first region 112. The example print material hopper 105 is shown to include an example fill port cover 330, an example front side 340, an example first lateral side 350 and an example second lateral side 355. An example print material, such as a 3D print powder (e.g., a nylon powder, a thermoplastic polyurethane (TPU) powder, a metal powder, etc.) is input into the example print material hopper 105 through an opening in a top portion of the example print material hopper 105 following removal or displacement of the example fill port cover 330. An example drive system 360 is shown adjacent the example first lateral side 350. The example drive system 360 moves the example print material hopper 105 along a path from the example discharge opening isolator 110 to and across the example second region 115, as shown by way of example in FIG. 10 and FIG. 2C. In some examples, the drive system is a belt and pulley driven system, with a belt running from a front of the example print material hopper 105 to the back of the example print material hopper 105 and with the belt being attached to a bracket that rides along a guide rod. The bracket holds onto the example print material hopper 105 and provides a downward force on the example print material hopper 105 as well as a translational force applied by the belt and pulley system. In some examples, a motor used to drive the example print material hopper 105 includes an A7W93-60611 motor manufactured by Johnson Electric of Hong Kong. In some examples, the example drive system 360 includes an example DC motor having a pinion on an output shaft of the DC motor connected, via a gear train including one or more gears, to a rack adjacent the path from the example discharge opening isolator 110 to and across the example second region 115. The example discharge opening isolator 110 includes an example first lateral side 370 and an example second lateral side 375.

FIG. 4 is a bottom rear perspective view of the example print material hopper 105 of FIG. 3. FIG. 4 shows the example front side 340, the example first lateral side 350 and the example second lateral side 355. In addition, FIG. 4 shows an example rear side 400. Collectively, the example front side 340, the example first lateral side 350, the example second lateral side 355 and the example rear side 400 define an example internal volume 410 to retain the print material.

FIG. 4 shows an example first datum 420 extending along the example first lateral side 350 of the example print material hopper 105 and an example second datum 425 extending along the example second lateral side 355 of the example print material hopper 105. When disposed in an operative position, such as shown in the examples of FIGS. 1A-3, the example first datum 420 and the example second datum 425 are disposed to contact the example delivery plate 120 of the example second region 115, as the print material hopper moves relative thereto, to respectively define a first lateral boundary and a second lateral boundary for the print material discharged from the discharge opening onto the example delivery plate 120. The first lateral side 350 and the first datum 420 of the example print material hopper 105 form a first boundary to limit a lateral spread of the discharged print material on the first side and the second lateral side 355 and the second datum 425 of the example print material hopper 105 form a second boundary to limit a lateral spread of the discharged print material on the second side.

In some examples, a width between the example first lateral side 370 and the example second lateral side 375 (FIG. 3) of the example discharge opening isolator 110 is less than a width between the example first lateral side 350 and the example second lateral side 355 of the example print material hopper 105. During movement of the example print material hopper 105 along the example discharge opening isolator 110, the example first lateral side 350 and the example second lateral side 355 of the example print material hopper 105 slide outside of the example first lateral side 370 and the example second lateral side 375 of the example discharge opening isolator 110. In some examples, the example first lateral side 350 and the example second lateral side 355 of the example print material hopper 105 abut the example first lateral side 370 and the example second lateral side 375 of the example discharge opening isolator 110 during movement of the example print material hopper 105 along the example discharge opening isolator 110.

FIG. 4 also shows that the example print material hopper 105 includes an example third datum 430 extending along a bottom portion of the example front side 340 of the example print material hopper 105 and an example fourth datum 435 extends along a bottom portion of the example rear side 400 of the example print material hopper 105. The example third datum 430 and the example fourth datum 435 are spaced apart from the example first datum 420 and the example second datum 425 by a first height H1, shown in FIG. 5, to define a height H1 of the print material (see, e.g., print layer 140 in FIG. 10) discharged from an example discharge opening 450 defined by the example first lateral side 350, the example second lateral side 355 and the example rear side 400. The example discharge opening 450 discharges the print material as the example print material hopper 105 moves along the example delivery plate 120 with the example first datum 420 and the example second datum 425 contacting the example delivery plate 120.

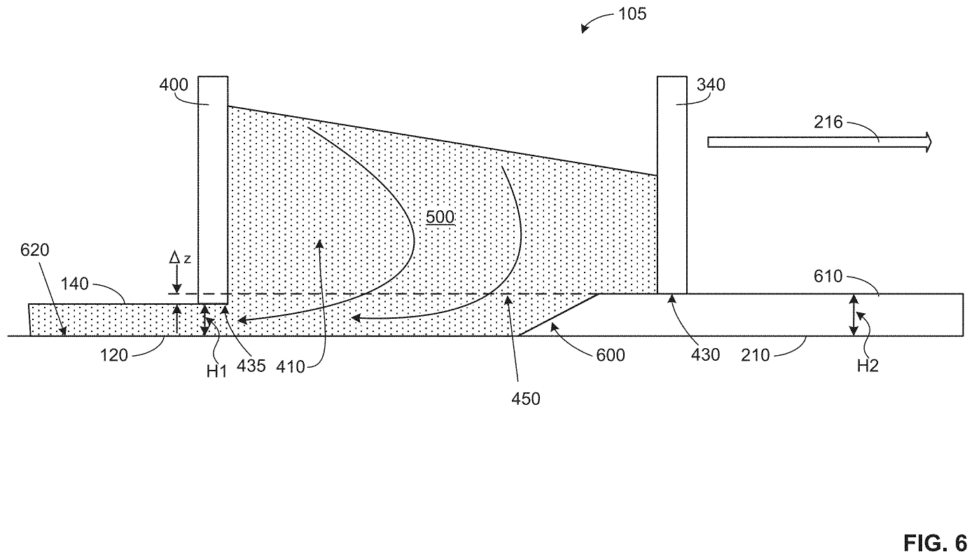

FIGS. 5-6 are cut-away side views showing an example print material hopper 105 moving in relation to an example delivery plate 120 to discharge an example layer 140 of powder on the example delivery plate 120. FIG. 5 is represented by the cross section 5-5 in FIG. 2B. FIG. 6 is represented by the cross section 6-6 in FIG. 2C. In the example cut-away views of FIGS. 5-6, the example first datum 420 and the example second datum 425, which contact the example delivery plate 120, are not shown. The example third datum 430 of the example front side 340 and the example fourth datum 435 of the example rear side 400 are spaced apart from the example delivery plate 120 by the first height H1. In the example of FIGS. 5-6, gravity acts on the example print material 500 to pull it through the example discharge opening 450. As gravity pulls the example print material 500 downwardly, the example rear side 400 and the example fourth datum 435 define a layer 140 of print material having a height H1 as the example print material hopper 105 moves in the direction of the arrow along the example delivery plate 120 with the example first datum 420 and the example second datum 425 contacting the example delivery plate 120. Following a spreading of the example layer 140, such as shown in FIG. 2E, when a direction of motion of the example print material hopper (e.g., 105) is reversed, such as shown in FIG. 2D, additional print material is permitted to be discharged onto the example delivery plate 120, with the example front side 340 and the example third datum 430 (now lagging) defining a next layer 140 of print material (see FIGS. 2E-2F) having a height H1 as the example print material hopper 105 moves in the direction of the arrow along the example delivery plate 120 with the example first datum 420 and the example second datum 425 contacting the example delivery plate 120.

FIG. 6 represents a movement of the example print material hopper 105 onto an example discharge opening isolator 210 following the movement indicated in the example of FIG. 5. FIG. 6 shows an example ramp 600 to provide a transition for the example print material hopper 105 between the example delivery plate 120 and the example discharge opening isolator 210. In some examples, no ramp 600 is provided and the example print material hopper 105 moves directly onto the example discharge opening isolator 210. In some examples, the example discharge opening isolator 210 and/or the example print material hopper 105 include chamfered, angled, rounded mating surfaces to facilitate motion of the example print material hopper 105 onto the example discharge opening isolator 210 upon contact between the example discharge opening isolator 210 and the example print material hopper 105. In some examples, example ramp 600 has a length less than or equal to a length of the example discharge opening isolator 210. In some examples, example ramp 600 has a length greater than a length of the example discharge opening isolator 210.

As shown in FIG. 6, an example upper surface 610 of the example discharge opening isolator 210 is disposed at a second height H2 from an example upper surface 620 of the example delivery plate 120, the second height H2 being greater than the height H1 of the example third datum 430 and the example fourth datum 435, thus creating an elevation difference of ΔH (i.e., H2-H1) between the example third datum 430 and the example fourth datum 435 with respect to the example discharge opening isolator 210. In some examples, the height H1 of the example discharge opening isolators 110, 210 is between about 1.0-4.5 mm (e.g., 1.6 mm, etc.). In some examples, the height H2 of the example discharge opening isolators 110, 210 is between about 0.0-1.5 mm higher than the height H1 (e.g., H2 is 0.1 mm-0.2 mm higher than H1).

In some examples, the example upper surface 610 of the example discharge opening isolator 210 is disposed at a height below a height of an example upper surface 620 of the example delivery plate 120 to place the example upper surface 610 below that of the height H1 of the example third datum 430 and the example fourth datum 435. While this example would not occlude discharge of print material from the example discharge opening 450 to the same degree as an example where the example upper surface 610 of the example discharge opening isolator 210 occludes the example discharge opening 450, it would nonetheless still provide a limitation to the discharge of print material from the example discharge opening 450 and would advantageously reduce friction acting on the example drive system and/or reduce or eliminate wear on the example third datum surface 430 and example fourth datum surface 435.

In FIG. 6, prior to engagement of the example print material hopper 105 with the example ramp 600, the example third datum 430 was at the height H1 (see, e.g., FIG. 1) from the example delivery plate 120. From the initial point of contact between the example print material hopper 105 and the example ramp 600, continued forward motion of the example print material hopper 105 in the direction of the arrow forces the example third datum 430 upwardly by the elevation difference of ΔH and onto the example upper surface 610 of the example discharge opening isolator 210. Further forward motion of the example print material hopper 105 in the direction of the arrow then forces the example fourth datum 435 upwardly by the elevation difference of ΔH, at which point the example print material hopper 105 will fully engage the example discharge opening isolator 210, which will occlude the example discharge opening 450 of the example print material hopper 105 to prevent discharge of the example print material 500 therefrom.

In some examples, the height H2 of the example discharge opening isolator 210 and/or the height H1 of the example third datum 430 and the example fourth datum 435 are adjustable to a selected height setting from a plurality of available height settings. In this manner, an elevation difference of ΔH between the height H2 of the example upper surface 610 of the example discharge opening isolators 110, 210 and the height H1 of the example third datum 430 and the example fourth datum 435 can be adjusted. Likewise, an elevation difference of ΔH between the height H2 of the example upper surface 610 of the example discharge opening isolators 110, 210 and the height H1 of the example third datum 430 and the example fourth datum 435 may be maintained, with the values of each H1 and H2 being increased proportionally, to permit a modification of the height H1 of the example layer 140 deposited on the example delivery plate 120. Selection of a different height H1 for a layer 140 of print material enables modification of the example print material hopper 105 to accommodate different print materials 500 possessing different characteristics (e.g., grain size, surface coefficient of friction, flowability, etc.). In some examples, rather than modification of a height H2 of the example discharge opening isolator 210 and/or the height H1 of the example third datum 430 and the example fourth datum 435, a plurality of differently configured example discharge opening isolators 210 having a plurality of different heights H2 sss(e.g., H2ₙ₋₂, H2ₙ₋₁, H2ₙ, H2ₙ₊₁, H2ₙ₊₂, etc., where n is an integer) and/or a plurality of differently configured example print material hoppers 105 having a plurality of different heights H1 for the example third datum 430 and the example fourth datum 435 (e.g., H1ₙ₋₂, H1ₙ₋₁, H1ₙ, H1ₙ₊₁, H1ₙ₊₂, etc., where n is an integer). In such example, an appropriate combination of an example discharge opening isolator 210 and example print material hopper 105 may be made from the plurality of different example discharge opening isolators 110, 210 and the plurality of different example print material hoppers 105 to provide a desired combination of H1, H2. In the example of FIG. 6, an example upper surface 610 of the discharge opening isolator 210 has a height (e.g., H2) above an example upper surface 620 of the example delivery plate 120. In some examples, an elevation of the example upper surface 610 of the example discharge opening isolators 110, 210 is different than an elevation of the example upper surface 620 of the example delivery plate 120.

In some examples, where an example ramp 600 is provided between the example discharge opening isolators 110, 210 and the example delivery plate 120, some discharge of the print material 500 will occur prior to engagement of the example discharge opening 450 of the example print material hopper 105 with a respective one of the example discharge opening isolators 110, 210. In some examples, residual print material on the example ramp 600 is pushed to a vacuum collection for removal. In some examples, residual print material on the example ramp 600 is driven toward the example delivery plate 120 on a next iteration of discharge of the print material 500, where it is the incorporated into the print material spread in the example print area 125.

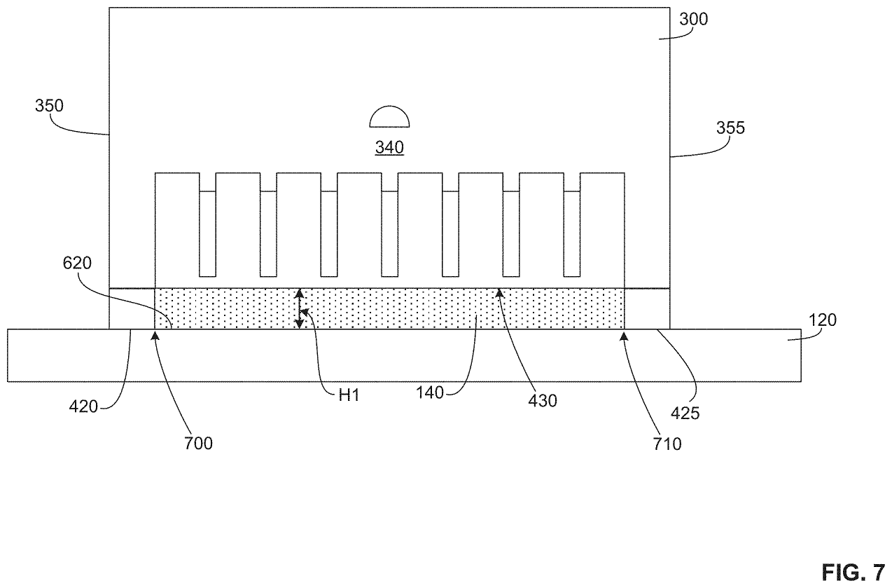

FIG. 7 shows an example front view of the example print material hopper 105 of FIG. 5 moving along the example delivery plate 120 and discharging a layer 140 of print material, as represented by the cross section 7-7 in FIG. 2B. The height of the layer is H1 relative to the example upper surface 620 of the example delivery plate 120, as is the height of the example third datum 430. The example first datum 420 and the example second datum 425 contact the example delivery plate 120 during movement of the print material hopper 105 along the example delivery plate 120 to respectively define a first lateral boundary 700 and a second lateral boundary 710 for the print material discharged from the discharge opening onto the example delivery plate 120. The first lateral side 350 and the first datum 420 form a first boundary to limit a lateral spread of the discharged print material on the first side and the second lateral side 355 and the second datum 425 form a second boundary to limit a lateral spread of the discharged print material on the second side.

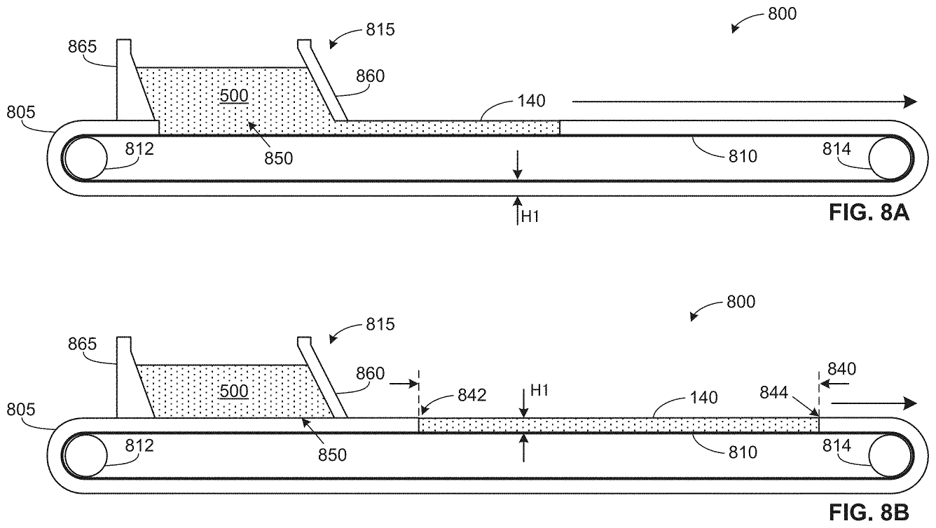

FIGS. 8A-8B are cut-away side views of an example first state (FIG. 8A) and an example second state (FIG. 8B) of an example 3D print material shut-off apparatus 800 of an example 3D printer. The example 3D print material shut-off apparatus 800 includes an example discharge opening isolator 805 disposed on an example belt 810 of an example belt and pulley system having an example first belt pulley 812 and an example second belt pulley 814.

The example 3D print material shut-off apparatus 800 also includes an example print material hopper 815 disposed in a fixed position relative to the example belt 810. An example gap 840 is formed between a first end 842 of the example discharge opening isolator 805 and a second end 844 of the example discharge opening isolator 805. As the example belt 810 drives the example discharge opening isolator 805 about the example first belt pulley 812 and the example second belt pulley 814 in a clockwise direction, the example gap 840 is intermittently presented beneath an example discharge opening 850 of the example print material hopper 815. As the example belt 810 moves (e.g., clockwise), the print material 500 flows into the example gap 840 under the influence of gravity and fills the example gap 840 to a height (e.g., H1) corresponding to the respective datums of the example print material hopper 815 and a height H1 of a top surface of the example discharge opening isolator 805.

FIG. 8A shows the example gap 840 of the example belt 810 disposed beneath the example discharge opening 850 to receive the print material 500 from the example discharge opening 850. FIG. 8B shows the example belt 810 positioned to bias the example discharge opening isolator 805 into abutment with the example discharge opening 850 to shut-off flow of a print material 500 from the example discharge opening 850.

Following formation of an example layer 140 of print material 500 on the example belt 810 in the example gap 840, the example layer 140 is positioned adjacent an example spreader and is stopped. The example spreader (e.g., 150; FIGS. 2A-2F) then spreads the layer 140 of the print material 500 over an example print area, such as shown in FIG. 2D, clearing the example gap 840 to receive print material 500.

In some examples, the example print material hopper 815 includes a front side 860 and a rear side 865 that are sloped in a direction of travel of the example belt 810. In some examples, the example front side 860 and the example rear side 865 of the print material hopper 815 are perpendicular to the direction of travel of the example belt 810.

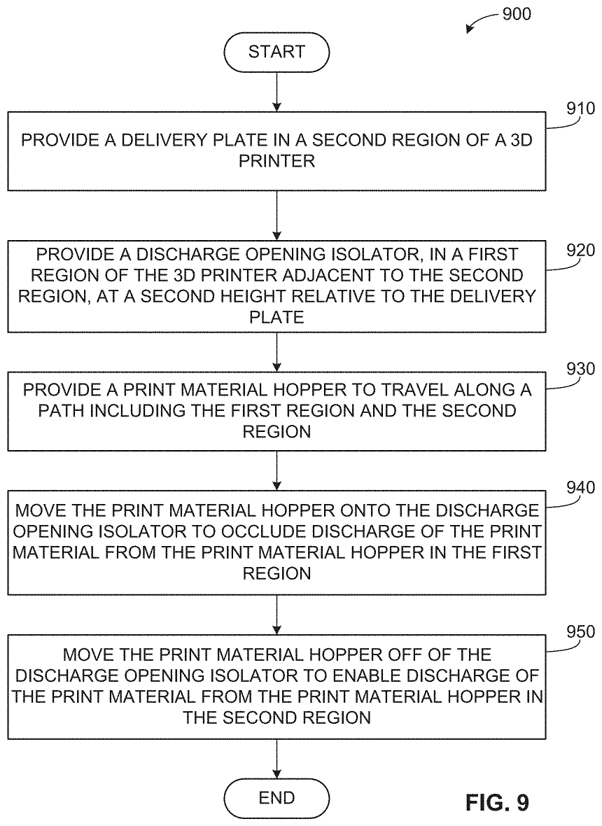

FIG. 9 is a flowchart representative of example method 900 which may be executed to implement the example discharge opening isolator (e.g., 110) of FIGS. 1A-8. At block 910, the example delivery plate 120 is provided with in the example second region 115 of the example 3D printer 100. At block 920, the example discharge opening isolator 110 is provided in the example first region 112 of the example 3D printer 100, which is adjacent the example second region 115. The example discharge opening isolator 110 is provided at a second height (e.g., H2) relative to the example upper surface (e.g., 620, FIG. 6) of the example delivery plate 120. At block 930, an example print material hopper 105 is provided to travel along a path including the example first region 112 and the example second region 115 of the example 3D printer 100.

At block 940, the example print material hopper 105 is moved onto the example discharge opening isolator 110 to occlude discharge of the print material 500 from the example print material hopper 105 in the example first region 112. At block 950, the example print material hopper 105 is moved off of the example discharge opening isolator 110 to enable discharge of the print material 500 from the example print material hopper 105 in the example second region 115.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A 3D print material shut-off apparatus, comprising:
a discharge opening isolator, disposed in a first region of a 3D printer; and
a print material hopper including a discharge opening at a bottom portion of the print material hopper to discharge a print material from the print material hopper in a second region of the 3D printer adjacent to the first region, and
wherein the discharge opening isolator is to occlude the discharge opening of the print material hopper when the print material hopper is in the first region.

2. The apparatus of claim 1, wherein the second region includes a print region of the 3D printer.

3. The apparatus of claim 1, wherein the second region includes a delivery plate adjacent a print region of the 3D printer.

4. The apparatus of claim 3, wherein the discharge opening isolator includes an upper surface having an area greater than an area of the discharge opening.

5. The apparatus of claim 4,
wherein a first datum extends along a bottom portion of a first lateral side of the print material hopper and a second datum extends along a bottom portion of a second lateral side of the print material hopper, and
wherein the first datum and the second datum are disposed to contact the delivery plate, as the print material hopper moves relative to the delivery plate, to respectively define a first lateral boundary and a second lateral boundary for the print material discharged from the discharge opening.

6. The apparatus of claim 5,
wherein a third datum extends along a bottom portion of a front side of the print material hopper and a fourth datum extends along a bottom portion of a rear side of the print material hopper, and
wherein the third datum and the fourth datum are spaced apart from the first datum and the second datum by a first height to define a height of the print material discharged from the discharge opening as the print material hopper moves along the delivery plate with the first datum and the second datum contacting the delivery plate.

7. The apparatus of claim 6, wherein an upper surface of the discharge opening isolator is disposed at a second height from the delivery plate.

8. The apparatus of claim 7, wherein the second height is greater than the first height.

9. The apparatus of claim 8, wherein the discharge opening isolator includes a ramp extending from the delivery plate to the second height along a path of the print material hopper from the delivery plate to the discharge opening isolator.

10. The apparatus of claim 9, wherein a width between a first lateral side and a second lateral side of the discharge opening isolator is less than a width between the first lateral side and the second lateral side of the print material hopper, and wherein, the first lateral side and the second lateral side of the print material hopper slide outside of the first lateral side and the second lateral side of the discharge opening isolator during movement of the print material hopper along the discharge opening isolator.

11. The apparatus of claim 10, wherein the first lateral side and the second lateral side of the print material hopper abut a first lateral side and a second lateral side of the discharge opening isolator during movement of the print material hopper along the discharge opening isolator.

12. The apparatus of claim 11, wherein the first height is between about 1.0-4.0 mm and wherein the second height is between about 0.0-1.5 mm higher than the first height.

13. The apparatus of claim 8, wherein the second height of the discharge opening isolator is adjustable to a selected second height, wherein the first height of the discharge opening isolator is adjustable to a selected first height, and wherein the selected second height is greater than the selected first height.

14. A method of isolating flow from a print material hopper comprising:
providing a delivery plate in a second region of a 3d printer;
providing a discharge opening isolator, in a first region of the 3d printer adjacent to the second region, at a second height relative to the delivery plate;
providing a print material hopper to travel along a path including the first region and the second region;
moving the print material hopper onto the discharge opening isolator to occlude discharge of the print material from the print material hopper in the first region; and
moving the print material hopper off of the discharge opening isolator to enable discharge of the print material from the print material hopper in the second region.

15. A 3D print material shut-off apparatus, comprising:
a movable 3D printer belt including a discharge opening isolator in a first region of the 3D printer belt and an example gap in a second region of the 3D printer belt; and
a print material hopper including a discharge opening at a bottom portion of the print material hopper,
wherein the 3D printer belt is to bias the discharge opening isolator into abutment with the discharge opening to shut-off flow of a print material from the discharge opening and is to place the gap of the 3D printer belt beneath the discharge opening to receive the print material from the discharge opening.
